(19) United States
(12) Patent Application Publication
(10) Pub. No.: US 2026/0164079 A1
(43) Pub. Date: Jun. 11, 2026

(54) DISPLAY DEVICE AND METHOD FOR CONTROLLING DISPLAY DEVICE

(71) Applicant: Samsung Electronics Co., Ltd., Suwon-si (KR)

(72) Inventor: Byoungjin CHOI, Suwon-si (KR)

(21) Appl. No.: 19/051,951

(22) Filed: Feb. 12, 2025

Related U.S. Application Data
(63) Continuation of application No. PCT/KR2023/008936, filed on Jun. 27, 2023.

(30) Foreign Application Priority Data
Aug. 12, 2022 (KR) 10-2022-0101582

(51) Int. Cl. H04N 21/43

(52) U.S. Cl. CPC H04N 21/43079

(57) ABSTRACT

A display device and a controlling method of the display device are provided. The display device includes a display, a first signal inputter, a second signal inputter, and a controller. The controller is configured to measure a signal input time difference between a time at which a first signal is received by the first signal inputter from a source device and a time at which a second signal is received by the second signal inputter from the source device. In a multi-display environment in which the display device receives the first signal and another display device receives the second signal, the controller is configured to perform, based on the measured signal input time difference, an operation for controlling a signal output time of the first signal received by the display device.

### CROSS-REFERENCE TO RELATED APPLICATIONS

This application is a continuation of International Application No. PCT/KR2023/008936 designating the United States, filed on Jun. 27, 2023, in the Korean Intellectual Property Receiving Office and claiming priority to Korean Patent Application No. 10-2022-0101582, filed on Aug. 12, 2022, in the Korean Intellectual Property Office, the disclosures of each of which are incorporated by reference herein in their entireties.

### BACKGROUND

### Field

The disclosure relates to a display device and a controlling method of the display device, and for example, to a display device for controlling signal outputs of display devices in a multi-display environment, and a controlling method of the display device.

### Description of Related Art

An image transmission interface through which an image signal is transmitted from an external source device to a display device may be various types, such as a D-subminiature (D-SUB) interface, a digital visual interface (DVI), a high-definition multimedia interface (HDMI), a display port (DP), etc. A display device may include various types of signal input and output ports respectively corresponding to image transmission interfaces, and the display device may receive various types of image signals through the image transmission interfaces.

Rules and regulations determined by each image transmission interface may vary, and thus, forms and structures, contents, etc. of image signals received through the image transmission interfaces may vary.

In a multi-display environment in which a plurality of image signals are received from one source device, and an image is displayed on a plurality of display devices, each display device may be connected to a different image transmission interface. When each display device receives a different image signal through a different image transmission interface, the signal received through the image transmission interface may have a different input time for each display device.

### SUMMARY

According to an example embodiment of the present disclosure, a display device may include: a display, a first signal inputter comprising circuitry, a second signal inputter comprising circuitry, and a controller comprising circuitry. The controller may be configured to: measure a signal input time difference between a time at which a first signal is received by the first signal inputter from a source device and a time at which a second signal is received by the second signal inputter from the source device. In a multi-display environment in which the display device receives the first signal and other display device receives the second signal, the controller may be configured to perform, based on the measured signal input time difference, an operation for controlling a signal output time of the first signal received by the display device.

According to an example embodiment of the present disclosure, a method of controlling a display device may include: measuring a signal input time difference between a time at which a first signal is received by a first signal inputter from a source device and a time at which a second signal is received by a second signal inputter from the source device, and in a multi-display environment in which the display device receives the first signal and another display device receives the second signal, controlling, based on the measured signal input time difference, a signal output time of the first signal received by the display device.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram for illustrating an example multi-display environment in which a plurality of display devices are connected to one source device through different cables from each other according to various embodiments;

FIG. 2 is a diagram illustrating a state of a plurality of display devices in a multi-display environment, when a power saving mode is entered into and then released, according to various embodiments;

FIG. 3 is a block diagram illustrating an example configuration of a display device according to various embodiments;

FIG. 4 is a block diagram illustrating an example configuration of a display device and a source device, according to various embodiments;

FIG. 5 is a flowchart illustrating an example controlling operation of a display device, according to various embodiments;

FIG. 6 is an diagram illustrating an example operation when a synchronization mode is not executed in a multi-display environment according to various embodiments;

FIG. 7 is a diagram illustrating an example operation, performed by a display device, of measuring a signal input time difference, according to various embodiments;

FIG. 8 is a diagram illustrating an example operation, performed by a display device, of controlling a first signal output time, based on a signal input time difference, in a multi-display environment, according to various embodiments;

FIG. 9 is a flowchart illustrating an example operation, performed by a display device, of measuring a signal input time difference according to a selection of a synchronization mode, according to various embodiments

FIG. 10 is a diagram illustrating an example operation of a display device, with respect to various operations of FIG. 9 according to various embodiments;

FIG. 11 is a diagram illustrating an example operation of a display device, with respect to an operation of FIG. 9 according to various embodiments;

FIG. 12 is a flowchart illustrating an example operation, performed by a display device, of guiding a cable change, as a signal input time difference is measured, according to various embodiments;

FIG. 13 is a diagram illustrating an example operation, performed by a display device, of providing a user interface for inducing a power saving mode to be entered into and then released, according to various embodiments;

FIG. 14 is a diagram illustrating an example operation, performed by a display device, of guiding a cable change, as a signal input time difference is measured, according to various embodiments;

FIG. 15 is a flowchart illustrating an example operation after a synchronization mode is executed in a multi-display environment, according to various embodiments;

FIG. 16 is a block diagram illustrating an example configuration of a display device and a source device, according to various embodiments;

FIG. 17 is a flowchart illustrating an example booting synchronization operation in a multi-display environment in which a synchronization mode is executed, according to various embodiments; and

FIG. 18 is a flowchart illustrating an example booting synchronization operation in a multi-display environment in which a synchronization mode is executed, according to various embodiments.

### DETAILED DESCRIPTION

The terms used herein will be briefly described and then the disclosure will be described in greater detail.

In the disclosure, general terms that have been widely used nowadays are selected, when possible, in consideration of functions of the disclosure, but non-general terms may be selected according to the intentions of technicians in the this art, precedents, or new technologies, etc. Various terms may be arbitrarily selected. In this case, the meanings of these terms will be explained in corresponding parts of the disclosure in detail. Thus, the terms used herein should be defined not based on the names thereof but based on the meanings thereof and the whole context of the disclosure.

Throughout the disclosure, it will be understood that when an element is referred to as “including” an element, the element may further include another element, rather than excluding the other element, unless mentioned otherwise. The terms, such as “unit” or “module,” used in the disclosure, should be understood as a unit that processes at least one function or operation and that may be embodied in a hardware manner, a software manner, or a combination of the hardware manner and the software manner.

Hereinafter, various example embodiments will be described in greater detail with reference to the accompanying drawings. However, the present disclosure may have different forms and should not be understood as being limited to the various embodiments described herein. In the drawings, parts not related to descriptions may be omitted for the clear description of the disclosure, and throughout the disclosure, like reference numerals are used for like elements.

The term “user” may denote a person controlling a function or an operation of a computing device or an electronic device using a controller and may also denote a viewer, a manager, or an installing technician.

Hereinafter, the present disclosure is described in greater detail with reference to the accompanying drawings.

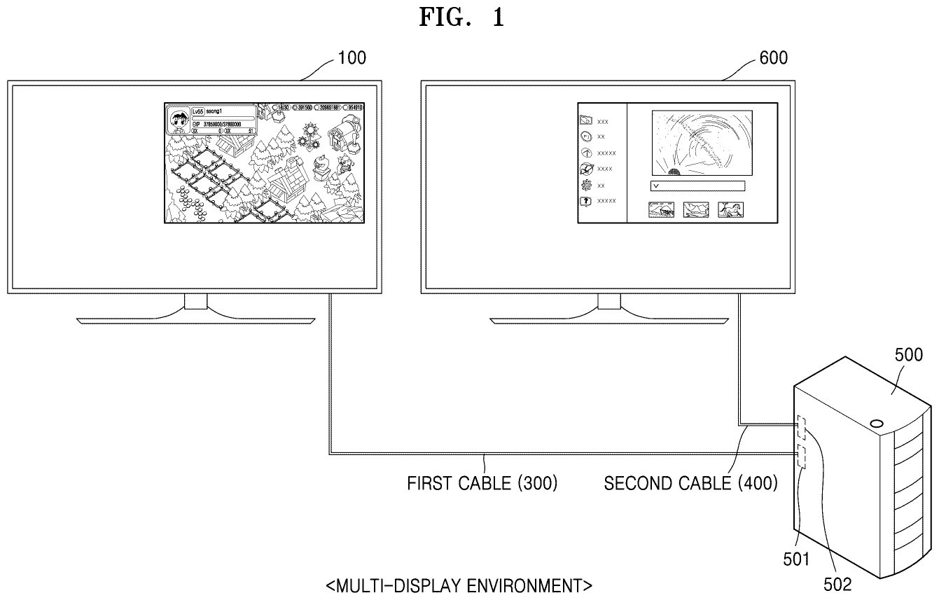

FIG. 1 is a diagram illustrating an example multi-display environment in which a plurality of display devices are connected to one source device through different cables from each other according to various embodiments.

Referring to FIG. 1, a system may include a source device 500 and a display device 100.

The source device 500 may provide content, such as video content, audio content, etc., to the display device 100. The source device 500 may include various types of electronic devices capable of providing content to the display device 100, such as a set-top box, a digital versatile disc (DVD) player, a Blu-ray disc player, a personal computer (PC) game machine, etc. The source device 500 may be referred to as a source device because the source device 500 provides content and, in addition thereto, may also be referred to as a host device, a content providing device, an electronic device, a computing device, etc.

The display device 100 may display the content received from the source device 500 on a screen. The display device 100 may include various types of electronic devices capable of receiving and outputting content, such as a network television (TV), a smart TV, an Internet TV, a web TV, an Internet protocol TV (IPTV), a PC, etc. The display device 100 may be referred to as a display device because the display device 100 receives and displays content and, in addition thereto, may also be referred to as a content receiving device, a synchronization device, an electronic device, a computing device, etc.

The source device 500 and the display device 100 may be connected to each other through various types of image transmission interfaces to perform content transmission and reception. The image transmission interfaces may be implemented, for example, as cables, and the source device 500 and the display device 100 may include one or more signal input and output ports to be connected to the cables. The image transmission interfaces may include, for example, a D-subminiature (D-SUB) interface, a digital visual interface (DVI), a high-definition multimedia interface (HDMI), a display port (DP), or a type-C interface. According to a type of the image transmission interface, an image signal exchanged between the source device 500 and the display device 100 may vary. The one or more signal input and output ports may transmit or receive image signals corresponding to the standards of the connected image transmission interface.

For example, the source device 500 and the display device 100 may be connected to each other through the image transmission interface implemented as an HDMI cable and may exchange an HDMI image signal with each other through an HDMI port included in each of the source device 500 and the display device 100. The source device 500 may transmit, to the display device 100, the HDMI image signal corresponding to the HDMI standards, and the display device 100 may receive, from the source device 500, the HDMI image signal. For example, the source device 500 and the display device 100 may be connected to each other through the image transmission interface implemented as a DP cable and may exchange a DP image signal with each other through a DP included in each of the source device 500 and the display device 100.

FIG. 1 illustrates a multi-display environment in which one source device 500 is connected to a plurality of display devices, and each of the plurality of display devices receives an image signal from the source device 500 and displays the image signal on a screen.

For example, the multi-display environment may include the source device 500, the display device 100, and another display device 600. In the multi-display environment, the display device 100 may be referred to as a “first display device 100,” and the other display device 600 may be referred to as a “second display device 600.”

The first display device 100 and the second display device 600 may be connected to one source device 500 through different cables from each other. For example, the first display device 100 may be connected to a first signal input and output port 501 of the source device 500 through a first cable 300. The second display device 600 may be connected to a second signal input and output port 502 of the source device 500 through a second cable 400.

The first cable 300 and the second cable 400 may include, for example, a D-SUB cable, a DVI cable, an HDMI cable, a DP cable, and a type-C cable. The first cable 300 may connect the source device 500 to the first display device 100. The second cable 400 may connect the source device 500 to the second display device 600.

The first display device 100 may receive a first image signal from the source device 500 through the first cable 300 and may display a first image 105, and the second display device 600 may receive a second image signal from the source device 500 though the second cable 400 and may display a second image 605. The first cable 300 and the second cable 400 may be the same type of image transmission interface or different types of image transmission interfaces.

Hereinafter, a case where the first cable 300 connected to the first display device 100 is a different type of image transmission interface from the second cable 400 connected to the second display device 600, is illustrated as an example. For example, the first cable 300 may be a DP cable, and the second cable 400 may be an HDMI cable. However, the disclosure is not limited thereto.

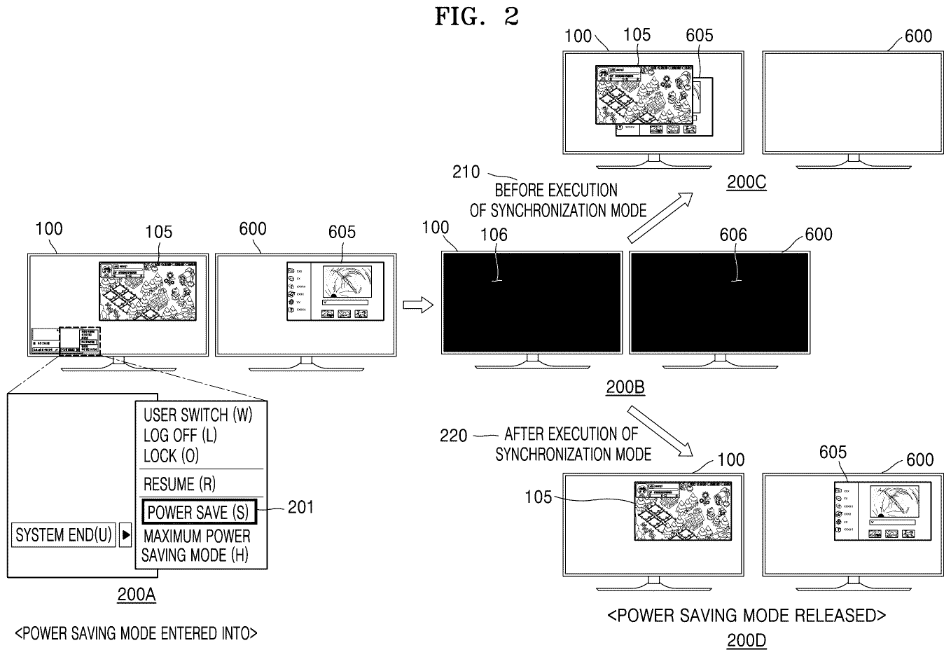

FIG. 2 is a diagram illustrating an example state of a plurality of display devices in a multi-display environment, when a power saving mode is entered into and then released, according to various embodiments.

FIG. 2 illustrates a state 200A of the display devices before the source device 500 enters into a power saving mode, a state 200B of the display devices after the source device 500 enters into the power saving mode, and a state 200C and a state 200D of the display devices after the source device 500 releases the power saving mode, in the multi-display environment.

200A of FIG. 2 indicates the state in which the first display device 100 displays the first image 105 according to a first signal received from the source device 500, and the second display device 600 displays the second image 605 according to a second signal received from the source device 500. In this case, an image transmission interface for the transmission of the second signal may be different from an image transmission interface for the transmission of the first signal.

In 200A of FIG. 2, any one of a plurality of methods, by which the source device 500 enters into the power saving mode, is illustrated. According to an embodiment, when a user selects a power saving menu 201, the source device 500 may enter into the power saving mode. When the source device 500 enters into the power saving mode, the plurality of display devices may also enter into a power saving mode, as indicated in 200B of FIG. 2.

200B of FIG. 2 indicates the state of the display devices when the source device 500 enters into the power saving mode, when each of the first display device 100 and the second display device 600 displays a signal by receiving the signal from the source device 500 through a different image transmission interface from each other, in the multi-display environment. Referring to 200B of FIG. 2, when the source device 500 enters into the power saving mode, the source device 500 may stop an operation of transmitting signals to the plurality of display devices. When the source device 500 enters into the power saving mode, the plurality of devices may not receive the signal from the source device 500, and thus, the plurality of devices may not display images, either, and may enter into a power saving mode. For example, according to the power saving mode of the source device 500, the first display device 100 and the second display device 600 may not receive signals from the source device 500, and thus, the first display device 100 and the second display device 600 may enter into the power saving mode, in which images are not displayed. The first display device 100 may output a black screen 106, and the second display device 600 may output a blue screen 606. 200C and 200D of FIG. 2 indicate the states in which the first display device 100 and the second display device 600 display signals again by receiving the signals from the source device 500, when the power saving mode of the source device 500 is released. For example, 200C of FIG. 2 indicates an operating state of a general case, and 200D of FIG. 2 indicates an operating state when a synchronization mode is executed according to embodiments of the present disclosure.

According to an embodiment, when the power saving mode of the source device 500 is released, the source device 500 may transmit a signal to each of the plurality of display devices. Each of the plurality of display devices receiving the signal from the source device 500 may release the power saving mode through a booting operation. The plurality of display devices, the booting operations of which are completed, may display images again according to the signals received from the source device 500.

200C of FIG. 2 indicates the state of the display devices displaying images when the source device 500 releases the power saving mode, before execution of a synchronization mode 210. Referring to 200C of FIG. 2, in the multi-display environment in which one source device 500 is connected to the plurality of display devices through the different types of image transmission interfaces, positions of images displayed on the plurality of display devices may be changed, when the source device 500 releases the power saving mode. For example, the second image 605 displayed on the second display device 600 before the power saving mode may be displayed on the first display device 100 after the power saving mode.

Referring to 200C of FIG. 2, when the source device 500 releases the power saving mode, there may be an input time difference between the signals received by the plurality of display devices through the different image transmission interfaces. For example, a time at which the first signal is input to the first display device 100 may be earlier or later than a time at which the second signal is input to the second display device 600.

As described above, when the times at which the signals are input to the plurality of display devices are different from each other, when the source device 500 enters into the power saving mode and then releases the power saving mode (or enters into the power saving mode and then exits from the power saving mode), booting time points of the plurality of display devices may be different from each other. The source device 500 may recognize that a cable connection is released, with respect to a display device having a delayed booting time point. The source device 500 may transfer a signal, transmitted to the display device, with respect to which the source device 500 recognizes that the cable connection is released, to another display device, with respect to which a cable connection is well maintained. Thus, when the plurality of display devices have different booting time points from each other, the source device 500 may transfer the signal transmitted to a display device slowly booted to another display device fast booted.

For example, each of the plurality of display devices may provide a hot plug detect (HPD) signal to the source device 500 through a cable, wherein each of the plurality of display devices may notify, through the HPD signal, the source device 500 of events, such as an unplug event, a plug/re-plug event, and a booting completion event.

For example, when a cable connected to any one of the plurality of display devices is released, any one signal input and output port of the source device 500 may not receive a voltage corresponding to a high level HPD signal, and thus, the signal input and output port may have a low level HPD signal. Through the low level HPD signal, the source device 500 may recognize that the cable connection with any one display device is released and may not provide a signal to the display device, with respect to which the cable connection is recognized to be released. Through another signal input and output port receiving a high level HPD signal, the source device 500 may recognize that a cable connection to another display device is well maintained and may provide a plurality of signals to the other display device.

When the source device 500 releases the power saving mode, and thus, the display devices receiving the signals are booted, the display devices may notify booting completion events to the source device 500 by providing HPD signals to the source device 500.

For example, when the power saving mode is released, the display devices may perform an HPD signal toggling operation for notifying the source device 500 of the completion of the booting operation. The HPD signal toggling operation may be an operation of switching a high level HPD signal to a low level HPD signal. The HPD signal toggling operation may be a preparation operation for notifying the source device 500 of an event that the display device is ready to display an image based on the received signal.

In a multi-display environment, a plurality of display devices may be connected to one source device through different image transmission interfaces from among a plurality of image transmission interfaces. The plurality of image transmission interfaces may have the different characteristics from each other, and thus, even when the source device 500 transmits signals at the same time point, signal input times may be different between the signals input by the display devices, respectively. When the signal input time of each of the plurality of display devices is different, a booting time point of each of the plurality of display devices may be different according to the signal input time difference. When the booting time points are different from each other, a time point of the HPD signal toggling operation of each of the plurality of display devices may be different from each other. When the time point of the HPD signal toggling operation is different from each other, the source device 500 may recognize that a display device is normally connected and another display device is not connected. Accordingly, when the power saving mode is released, the source device 500 may perform an operation of moving an image displayed on a display device to be displayed on another display device, similarly to the cable disconnection case described above.

For example, when the booting time points of the first display device 100 and the second display device 600 are different from each other, the source device 500 may recognize that the first display device 100 is normally connected, but a cable of the second display device 600 is disconnected. Thus, the second image 605 displayed on the second display device 600 before the power saving mode is entered into may be moved to the first display device 100 after the power saving mode is entered into. The present disclosure describes an example in which the first signal input to the first display device 100 is input earlier than the second signal input to the second display device 600. However, the disclosure is not limited thereto.

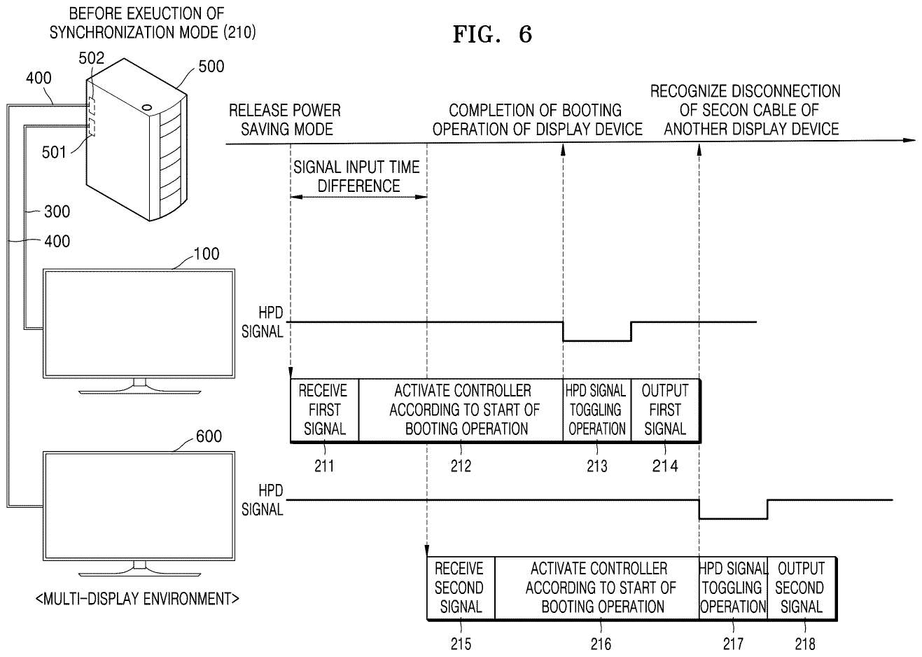

In this case, the second display device 600, a booting operation of which is delayed, may receive no signal from the source device 500, and thus, may not display an additional image. The first display device 100 may receive both of the first signal and the second signal, and thus, may display both of the first image 105 corresponding to the first signal, which is displayed by the first display device 100 before the power saving mode, and the second image 605 corresponding to the second signal, which is displayed on the second display device 600. Thus, before the power saving mode of the source device 500, the first image 105 may be displayed on the first display device 100, and the second image 605 may be displayed on the second display device 600, but after the power saving mode is entered into and released, both of the first image 105 and the second image 605 may be displayed on one display device, that is, the first display device 100. Thus, the position of the image may become different after the power saving mode is released. Thus, a user may recognize that a predetermined error has occurred in the display device, and thus, confusion may be incurred. Also, an additional operation of displaying the second image 605 again on the second display device 600 may be required, and thus, inconvenience may be caused for the user. This aspect will be described in greater detail below with reference to FIG. 6.

To address this problem, a synchronization mode may be executed, according to various embodiments. 200D of FIG. 2 indicates the state of the display devices displaying images when the source device 500 releases the power saving mode, after execution of a synchronization mode 220. According to an embodiment, when the synchronization mode is executed in the multi-display environment, positions of images displayed on the plurality of display devices may be maintained as positions before the power saving mode, even when the power saving mode of the source device 500 is released.

The synchronization mode, which is to be described below, may be an operation for synchronizing a booting time point, when an input time of a signal received by each of the plurality of display devices is different from each other. For example, in the multi-display environment in which the synchronization mode is executed, a booting time point of the first display device 100 may be the same or substantially the same as a booting time point of the second display device 600. When an input time of a signal received by the first display device 100 is earlier than an input time of a signal received by the second display device 600, the first display device 100 may perform an operation of delaying the booting time point. By delaying the booting time point of the first display device 100 having the earlier signal input time, the booting time point of the first display device 100 may be synchronized to the booting time point of the second display device 600.

Accordingly, even when the input time of the first signal received by the first display device 100 is different from the input time of the second signal received by the second display device 600 in the multi-display environment, the booting time points may be synchronized to each other, and an output time of the first signal and an output time of the second signal may be synchronized to each other, and thus, the positions of the first image 105 displayed on the first display device 100 and the second image 605 displayed on the second display device 600 may be maintained. That is, even when the power saving mode is used in the multi-display environment, positions of images configured by a user may not be changed, and thus, user convenience may be improved.

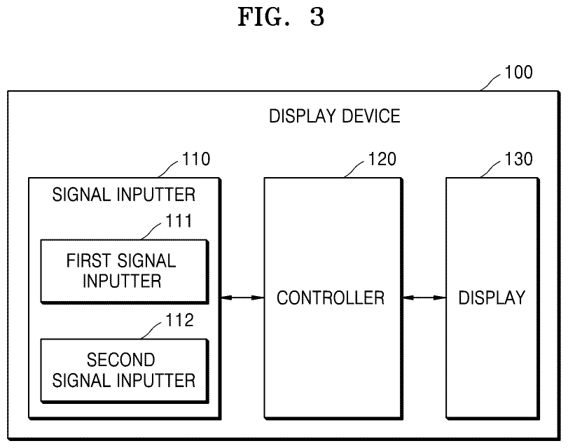

FIG. 3 is a block diagram illustrating an example configuration of the display device 100 according to various embodiments.

Referring to FIG. 3, the display device 100 may include a signal inputter (e.g., including circuitry) 110, a controller (e.g., including control/processing circuitry) 120, and a display 130.

The signal inputter 110 may include various circuitry and receive, from an external device (for example, the source device 500), an image signal according to a connected protocol, according to control by the controller 120. The signal inputter 110 may include a first signal inputter 111 and a second signal inputter 112.

The first signal inputter 111 may be any one of a D-SUB signal inputter, a DVI signal inputter, an HDMI signal inputter, and a DP signal inputter. The second signal inputter 112 may be any one of a D-SUB signal inputter, a DVI signal inputter, an HDMI signal inputter, and a DP signal inputter.

The controller 120 may include various control/processing circuitry and control general operations of the display device 100 and may process and display, on the display 130, the image signal transmitted from the source device 500. Where the controller is provided in the form of a processor, the processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The display 130 may display an image according to the received image signal. The display 130 may include a screen or a display panel of the display device 100.

In the display device 100 according to an embodiment of the present disclosure, the controller 120 may measure a signal input time difference, which is a difference between a time at which a first signal is received by the first signal inputter 111 from the source device 500 and a time at which a second signal is received by the second signal inputter 112 from the source device 500. In a multi-display environment in which the display device 100 receives the first signal, and another display device 600 receives the second signal, the controller 120 may perform an operation of controlling a signal output time of the first signal received by the display device 100, based on the measured signal input time difference.

Even when a signal input time is different between the first signal input to the display device 100 and the second signal input to the other display device 600, positions of an image displayed on the display device 100 and an image displayed on the other display device 600 may be maintained. That is, even when a power saving mode is used in the multi-display environment, image movement between the plurality of display devices may be prevented and/or reduced. Because the positions of images configured by a user are not changed, user convenience may be improved.

For example, the operation of controlling the signal output time of the first signal may include an operation of delaying a signal output of the first signal as required to match a time corresponding to the signal input time difference.

According to an embodiment, in order to control the signal output time of the first signal received by the display device 100, the controller 120 may perform an operation of delaying a booting time point as required to match the time corresponding to the signal input time difference. According to an embodiment, the controller 120 may perform an operation of delaying an HPD signal toggling operation of toggling an HPD signal from a high level to a low level, as required to match the time corresponding to the signal input time difference.

According to an embodiment, the controller 120 may provide a user interface for selecting a synchronization mode of the output time of the first signal received by the display device 100 and an output time of the second signal received by the other display device 600 in the multi-display environment, and according to a selection of the synchronization mode through the user interface, may output a message guiding the source device 500 and the display device 100 to be connected to each other so that the first signal from the source device 500 may be received by the first signal inputter 111 of the display device 100, and the second signal from the source device 500 may be received by the second signal inputter 112 of the display device 100.

According to an embodiment, according to the first signal inputter 111 and the second signal inputter 112 being connected to the source device 500 so that the first signal from the source device 500 may be received by the first signal inputter 111 of the display device 100 and the second signal from the source device 500 may be received by the second signal inputter 112 of the display device 100, the controller 120 may provide a user interface for inducing the source device 500 to enter into or release a power saving mode, and according to the source device 500 entering into and then releasing the power saving mode, may measure a signal input time difference, which is a difference between a time at which the first signal is received and a time at which the second signal is received.

According to an embodiment, the controller 120 may provide a user interface for guiding the source device 500 and the other display device 600 to be connected to each other, so that the second signal, which is a later input signal of the first and second signals, based on the signal input time difference, may be input to the other display device 600.

According to an embodiment, the first signal may be received by the first signal inputter 111 through an Aux channel, and the second signal may be received by the second signal inputter 112 through a transition minimized differential signaling (TMDS) line according to a TMDS clock signal.

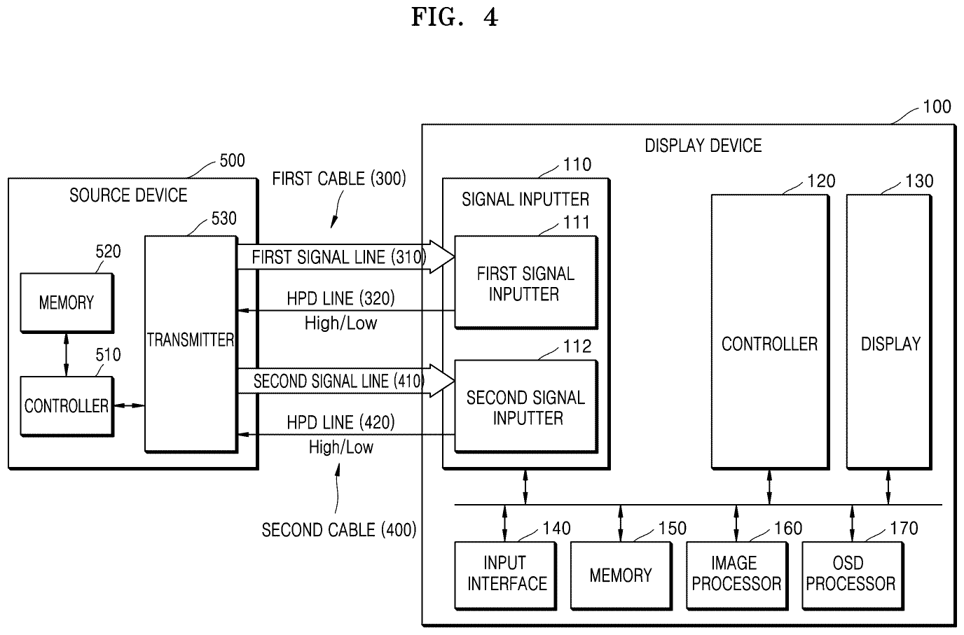

FIG. 4 is a block diagram illustrating an example configuration of the display device 100 and the source device 500, according to various embodiments.

Referring to FIG. 4, the display device 100 may include an input interface (e.g., including circuitry) 140, a memory 150, an image processor (e.g., including image processing circuitry) 160, and an on-screen-display (OSD) processor (e.g., including OSD processing circuitry) 170, in addition to the signal inputter 110, the controller 120, and the display 130.

The source device 500 may include a controller (e.g., including control/processing circuitry) 510, a memory 520, and a transmitter (e.g., including circuitry) 530. The display device 100 and the source device 500 may be connected to each other through the first cable 300 and/or the second cable 400.

The display device 100 is described.

The display device 100 may process and output an image signal received from the source device 500.

The signal inputter 110 may include circuitry and receive, from the source device 500, the image signal according to a connected protocol and output the received image signal to the image processor 160. The signal inputter 110 may include the first signal inputter 111 and the second signal inputter 112.

The controller 120 may include random-access memory (RAM), used as a storage corresponding to various jobs performed in the display device 100, read-only memory (ROM) in which control programs are stored, and a processor. Where the controller 120 includes a processor, the processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The controller 120 according to an embodiment may operate in a first power mode having a high-speed clock signal, before the display device 100 enters into a power saving mode or after the display device 100 releases the power saving mode. When the display device 100 enters into the power saving mode, the controller 120 may operate by switching to a second power mode having a low-speed clock signal. The second power mode may have lower power consumption than the first power mode. According to an embodiment, a booting operation may be an operation, in which the controller 120 switches from the second power mode to the first power mode, when the power saving mode is released.

The controller 120 according to an embodiment may include a low power controller and a main controller. When the display device 100 enters into the power saving mode, the low power controller may be activated, and the main controller may be deactivated. The low power controller may determine whether or not an image signal is input to the signal inputter 110, and thus, when the image signal is input to the signal inputter 110 as the power saving mode is released, may activate the main controller by transmitting an activation signal (or a wake-up signal) to the main controller. According to an embodiment, the booting operation may be an operation, performed by the lower power controller, of activating the main controller by providing an activation signal to the main controller, when the power saving mode is released.

The display 130 may display an image according to the image signal received from the image processor 160 and an OSD received from the OSD processor 170. The display 130 may include a screen of the display device 100.

The input interface 140 may include various circuitry and be configured to receive an input from a user. The input interface 140 may include at least one of a key pad, a dome switch, a touch panel, a jog wheel, a jog switch, or an infrared key, but is not limited thereto.

The memory 150 may store a program related to an operation of the display device 100 and various pieces of data generated during the operation of the display device 100. For example, the memory 150 may store a signal input time difference between the first signal received by the first signal inputter 111 of the display device 100 and the second signal received by the second signal inputter 112 of the display device 100.

The image processor 160 may include image processing circuitry and process the image signal received from the signal inputter 110 and output the processed image signal to the display 130, according to control by the controller 120. The image processor 160 may process image quality and perform scaling according to a type of the image signal.

The OSD processor 170 may include OSD processing circuitry and process an execution screen for controlling the display device 100 as an OSD and output the OSD to the display 130. For example, the OSD processor 170 may process a user interface for selecting a synchronization mode as an OSD and output the OSD to the display 130, according to control by the controller 120. For example, according to a selection of the synchronization mode, the OSD processor 170 may process a message guiding the display device 100 and the source device 500 to be connected to each other as an OSD and may output the OSD to the display 130. For example, the OSD processor 170 may process a user interface for guiding the source device 500 to enter into a power saving mode as an OSD and output the OSD to the display 130. The OSD processor 170 may process a user interface for guiding a cable, with respect to which a signal input delay occurs, to be connected to another display device, as an OSD, and output the OSD to the display 130, according to control by the controller 120.

Referring to FIG. 4, the source device 500 is described.

The controller 510 may include various control/processing circuitry and control general operations of the source device 500, may control a processing operation of an image signal to be transmitted to the display device 100, and may control the processed image signal to be output through the transmitter 530. Where the controller 510 includes a processor, the processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 520 may store a program related to an operation of the source device 500 and various pieces of data generated during the operation of the source device 500.

The transmitter 530 may include various circuitry and output an image signal having a resolution that may be processed by the display device 100. The transmitter 530 may read extended display identification data (EDID) including information about the display characteristics, such as a resolution, which is supportable by the display device 100, etc. The transmitter 530 may be implemented by at least one signal input and output port, for example, a first signal input and output port 501 or a second signal input and output port 502 of FIG. 1.

The transmitter 530 of the source device 500 and the signal inputter 110 of the display device 100 may be connected to each other through one or more cables. A case in which the transmitter 530 of the source device 500 and the first signal inputter 111 of the display device 100 are connected to each other through the first cable 300, and the transmitter 530 of the source device 500 and the second signal inputter 112 of the display device 100 are connected to each other through the second cable 400 is described.

The first cable 300 may include a first signal line 310 through which a first image signal is transmitted from the first signal inputter 111 and an HPD line 320 for identifying whether or not the transmitter 530 of the source device 500 and the first signal inputter 111 of the display device 100 are connected to each other.

When the first cable 300 according to an embodiment is a DP cable, the first signal line 310 may include a main link for transmitting the first image signal and an Aux channel. The source device 500 may reconfigure the first image signal to be transmitted through the main link by converting the first image signal into a predetermined form and may transmit the reconfigured first image signal to the first signal inputter 111 of the display device 100. The Aux channel may be used for managing the main link and controlling the device.

The HPD line 320 may be a signal line configured to notify the connection of the display device 100 to the source device 500. The HPD line 320 may output an HPD signal to the source device 500. For example, through the HPD line 320, the display device 100 may transmit, to the transmitter 530 of the source device 500, an HPD signal having a high level voltage. The HPD signal may notify the source device 500 of an unplug event, a plug/re-plug event, a booting completion event, etc. For example, through a high-level HPD signal received through the HPD line 320, the transmitter 530 of the source device 500 may identify that the source device 500 and the display device 100 are connected to each other. For example, through a low-level HPD signal received through the HPD line 320, the transmitter 530 of the source device 500 may identify that the connection between the source device 500 and the display device 100 is released.

The source device 500 receiving the high-level HPD signal may transmit, to the display device 100, an EDID request signal with respect to the display characteristics information, and the display device 100 may provide, to the source device 500, EDID of the display device 100. Through the first signal line 310, the transmitter 530 of the source device 500 may transmit, to the first signal inputter 111 of the display device 100, a first image signal image-processed based on the display characteristics information.

The second cable 400 may include a second signal line 410 through which a second image signal is transmitted from the second signal inputter 112 and an HPD line 420 for identifying whether or not the transmitter 530 of the source device 500 and the second signal inputter 112 of the display device 100 are connected to each other.

When the second cable 400 according to an embodiment is an HDMI cable, the second signal line 410 may include a TMDS line configured to transmit the second image signal. Through the TMDS line, the source device 500 may transmit, to the second signal inputter 112 of the display device 100, an image signal by converting the image signal into a predetermined form. The second image signal may be input to the second signal inputter 112 according to a TMDS clock signal.

The HPD line 420 may output an HPD signal to the source device 500. For example, through the HPD line 420, the display device 100 may transmit, to the transmitter 530 of the source device 500, an HPD signal having a high level voltage. Through the high-level HPD signal received through the HPD line 420, the transmitter 530 of the source device 500 may identify that the source device 500 and the display device 100 are connected to each other.

The source device 500 receiving the HPD signal may transmit, to the display device 100, an EDID request signal with respect to the display characteristics information, and the display device 100 may provide, to the source device 500, EDID of the display device 100. Through the second signal line 410, the transmitter 530 of the source device 500 may transmit, to the second signal inputter 112 of the display device 100, a second image signal image-processed based on the display characteristics information.

In this case, a time at which the first image signal is input to the first signal inputter 111 through the first signal line 310 may be different from a time at which the second image signal is input to the second signal inputter 112 through the second signal line 410. For example, the time at which the first image signal is received by the first signal inputter 111 through the Aux channel may be earlier than the time at which the second image signal is received by the second signal inputter 112 through the TMDS line according to the TMDS clock signal. However, it is not limited thereto.

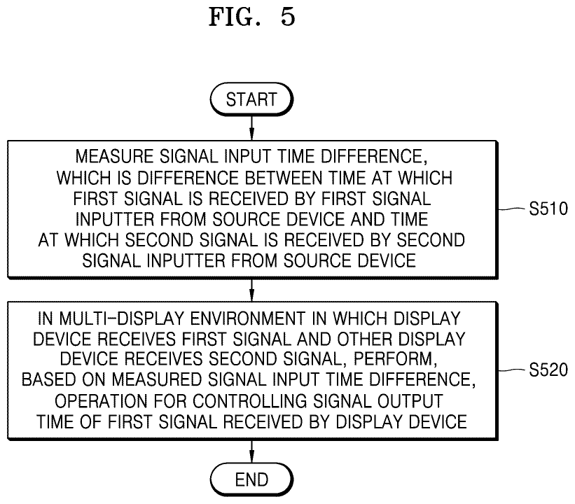

FIG. 5 is a flowchart illustrating an example controlling operation of the display device 100, according to various embodiments.

In operation S510, the controller 120 of the first display device 100 may measure a signal input time difference, which is a difference between a time at which the first signal is received by the first signal inputter 111 from the source device 500 and a time at which the second signal is received by the second signal inputter 112 from the source device 500. The first signal may be a DP image signal transmitted through the Aux channel, and the second signal may be an HDMI image signal transmitted through the TMDS line. However, it is not limited thereto.

According to an embodiment, when the first signal received by the first signal inputter 111 is input to the first display device 100 earlier than the second signal received by the second signal inputter 112, the controller 120 may measure the signal input time difference between the first signal and the second signal. The controller 120 may store the signal input time difference in the memory 150.

In operation S520, in a multi-display environment in which the first display device 100 receives the first signal, and the second display device 600 receives the second signal, the controller 120 may perform, based on the measured signal input time difference, an operation of controlling a signal output time of the first signal received by the display device 100.

For example, in the multi-display environment in which the first display device 100 is connected to the source device 500 through the first cable 300 and receives the first signal, and the second display device 600 is connected to the source device 500 through the second cable 400 and receives the second signal, a time at which the first signal is input to the first display device 100 connected through the first cable 300 may be earlier than a time at which the second signal is input to the second display device 600 connected through the second cable 400. In this case, in order to synchronize a time at which the first signal of the first display device 100 is output to a time at which the second signal of the second display device 600 is output, the time at which the first signal of the first display device 100 is output may be delayed as required to match the signal input time difference.

Accordingly, even when the time at which the first signal is input to the first display device 100 and the time at which the second signal is input to the second display device 600 are different from each other in the multi-display environment, the output of the first signal and the output of the second signal may be synchronized to each other, and thus, positions of an image displayed on the first display device 100 and an image displayed on the second display device 600 may be maintained. That is, even when a power saving mode is used in the multi-display environment, positions of images configured by a user may not be changed, and thus, user convenience may be improved.

FIG. 6 is a diagram illustrating an example operation when a synchronization mode is not executed in a multi-display environment according to various embodiments.

By referring to FIG. 6, an operation process in the multi-display environment before execution of the synchronization mode, according to 210 of FIG. 2, is described.

When a power saving mode of the source device 500 is released, the first signal inputter 111 of the first display device 100 may receive (211) the first signal from the source device 500, and a second signal inputter (not shown) of the second display device 600 may receive (215) the second signal from the source device 500. The controller 120 of the first display device 100 receiving the first signal may be activated (212) as a booting operation is started. The controller 120, which is activated, may perform an HPD signal toggling operation (213) to notify the source device 500 of completion of the booting operation. The HPD signal toggling operation may be an operation of providing an HPD signal to the source device 500 by switching the HPD signal having a high level to the HPD signal having a low level. The HPD signal may notify the source device 500 of a botting completion event. Through the HPD signal toggling operation, the source device 500 may recognize the booting completion of the first display device 100. The controller 120 may output (214) the first signal received by the first signal inputter 111. For example, the controller 120 may output, to the display 130, a first image (105 of FIG. 2) obtained by the image processor 160 by processing the first signal.

A time at which the first signal inputter 111 of the first display device 100 receives (211) the first signal may be earlier than a time at which the second signal inputter of the second display device 600 receives (215) the second signal. Thus, a signal input time difference, which is a difference between the time at which the first signal is input to the first display device 100 and the time at which the second signal is input to the second display device 600, may occur. Due to the signal input time difference, a time point at which the first display device 100 is booted (212) may be different from a time point at which the second display device 600 is booted (216). When the booting time points are different from each other, a time point of the HPD signal toggling operation (213) of the first display device 100 and a time point of an HPD signal toggling operation (217) of the second display device 600 may be different from each other. Thus, while the source device 500 receives an HPD signal having a high level from the first display device 100, the source device 500 may receive an HPD signal having a low level from the second display device 600. When the source device 500 receives the HPD signal having the low level according to the HPD signal toggling operation of the second display device 600, the source device 500 may recognize that the second display device 600 is disconnected from the source device 500 due to a disconnection of the second cable 400. Thus, the source device 500 may provide the second signal together with the first signal to the first display device 100 and may not provide the second signal to the second display device 600. Accordingly, in a general operation in which the synchronization mode is not executed, when the power saving mode of the source device 500 is released, a second image (605 of FIG. 2), displayed on the second display device 600 before the power saving mode is entered into, may be transferred to the first display device 100 and displayed together with the first image 105 on the first display device 100, after the power saving mode is released. The display device 600 may output (218) the second signal after performing the HPD signal toggling operation (217).

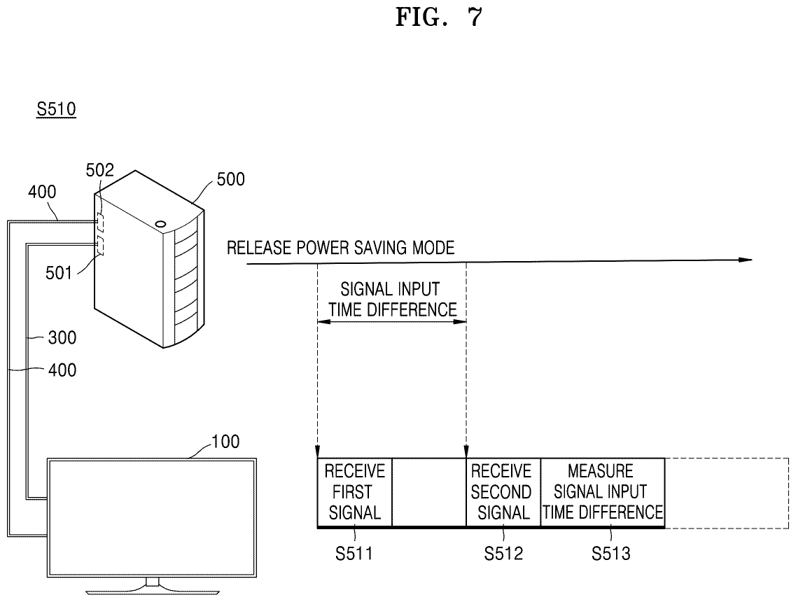

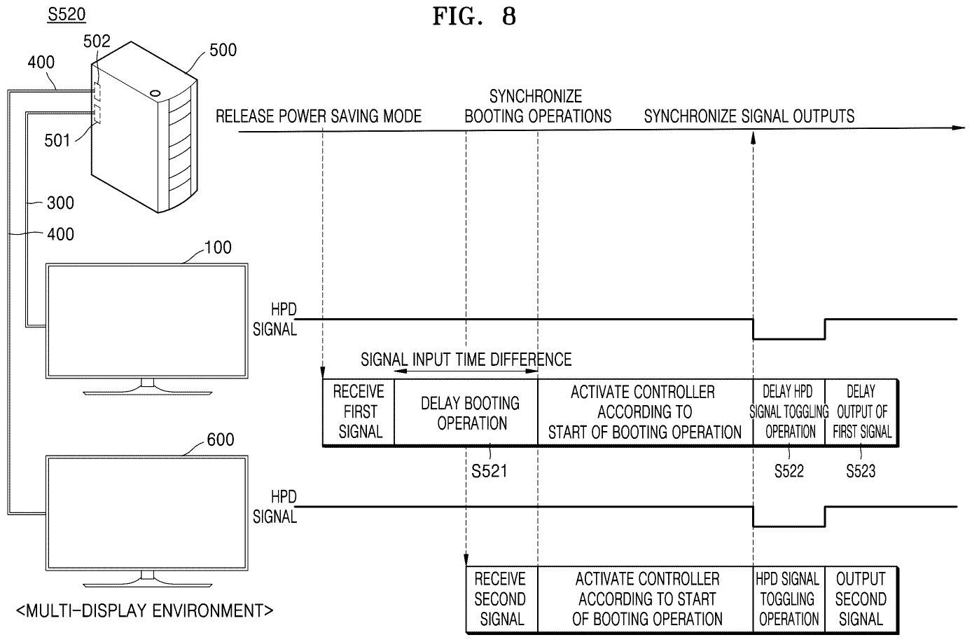

Referring to FIGS. 7 and 8, an operation process in the multi-display environment, when the synchronization mode is executed, is described, according to various embodiments.

FIG. 7 is a diagram illustrating an example operation, in which the display device 100 measures a signal input time difference, according to various embodiments. FIG. 8 is a diagram illustrating an example operation, in which the display device 100 controls an output time of the first signal based on the signal input time difference, in the multi-display environment, according to various embodiments.

FIG. 7 illustrates an operation process of the first display device 100 with respect to operation S510 of FIG. 5, and FIG. 8 illustrates an operation process of the first display device 100 with respect to operation S520 of FIG. 5.

Referring to FIG. 7, the source device 500 and the first display device 100 may be connected to each other through the first cable 300 and the second cable 400 that are different image interfaces from each other. The first signal inputter 111 of the first display device 100 may receive the first signal from the source device 500 through the first cable 300, and the second signal inputter 112 of the first display device 100 may receive the second signal from the source device 500 through the second cable 400, in operation S510.

According to an embodiment, when a power saving mode of the source device 500 is released, the first signal inputter 111 may receive the first signal in operation S511. Next, the second signal inputter 112 may receive the second signal in operation S512. The controller 120 may measure a signal input time difference between the first signal received by the first signal inputter 112 and the second signal received by the second signal inputter 112, in operation S513. The measured signal input time difference may be stored in the memory 150. The controller 120 may store the fact that a slower input signal of the first signal and the second signal is the second signal in the memory 150.

The first signal may be a DP image signal transmitted through the Aux channel, and the second signal may be an HDMI image signal transmitted through the TMDS line. However, it is not limited thereto.

Referring to FIG. 8, in the multi-display environment, the first display device 100 may be connected to the source device 500 through the first cable 300, and the second display device 600 may be connected to the source device 500 through the second cable 400. In the multi-display environment, the controller 120 may perform, based on the measured signal input time difference, an operation of controlling a signal output time of the first signal received by the first display device 100.

For example, in operation S521, the controller 120 may perform an operation of delaying a booting operation of the first display device 100 as required to match a time corresponding to the signal input time difference stored in the memory 150. Accordingly, a booting time point of the first display device 100 and a booting time point of the second display device 600 may be synchronized to each other.

In operation S522, the controller 120 may perform an operation of delaying an HPD signal toggling operation of the first display device 100 as required to match the time corresponding to the signal input time difference. Accordingly, a time point of the HPD signal toggling operation of the first display device 100 and a time point of an HPD signal toggling operation of the second display device 600 may be synchronized to each other. Accordingly, the source device 500 may simultaneously receive high-level HPD signals from the first display device 100 and the second display device 600 and simultaneously receive low-level HPD signals from the first display device 100 and the second display device 600. Accordingly, the source device 500 may recognize that the each of the plurality of devices is normally connected to the source device 500.

In operation S523, according to the delayed booting operation, the controller 120 may perform an operation of delaying the signal output time of the first signal of the first display device 100 as required to match the time corresponding to the signal input time difference. Accordingly, the signal output time of the first signal of the first display device 100 and a signal output time of the second signal of the second display device 600 may be synchronized to each other.

Thus, even when there is the signal input time difference between the first signal input to the first display device 100 and the second signal input to the second display device 600 in the multi-display environment, the booting time points of the plurality of display devices may be synchronized to each other, and thus, positions of the first image (105 of FG. 2) displayed on the first display device 100 and the second image (605 of FIG. 2) displayed on the second display device 600 may be maintained. That is, even when the power saving mode is released after being set in the multi-display environment, positions of the images configured by a user may not be changed, and thus, user convenience may be improved.

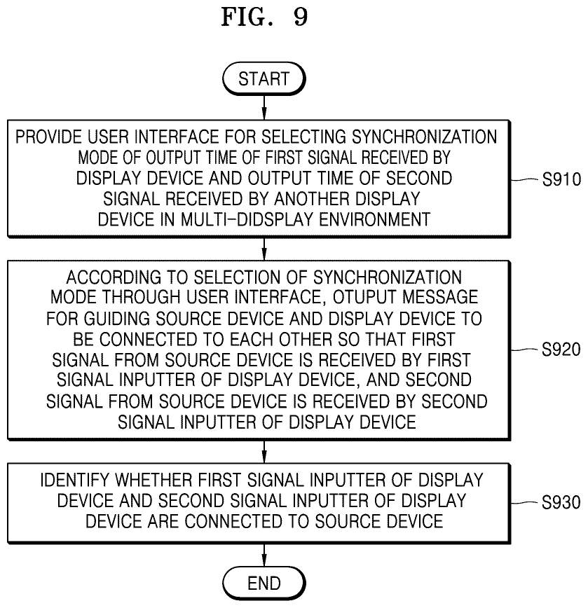

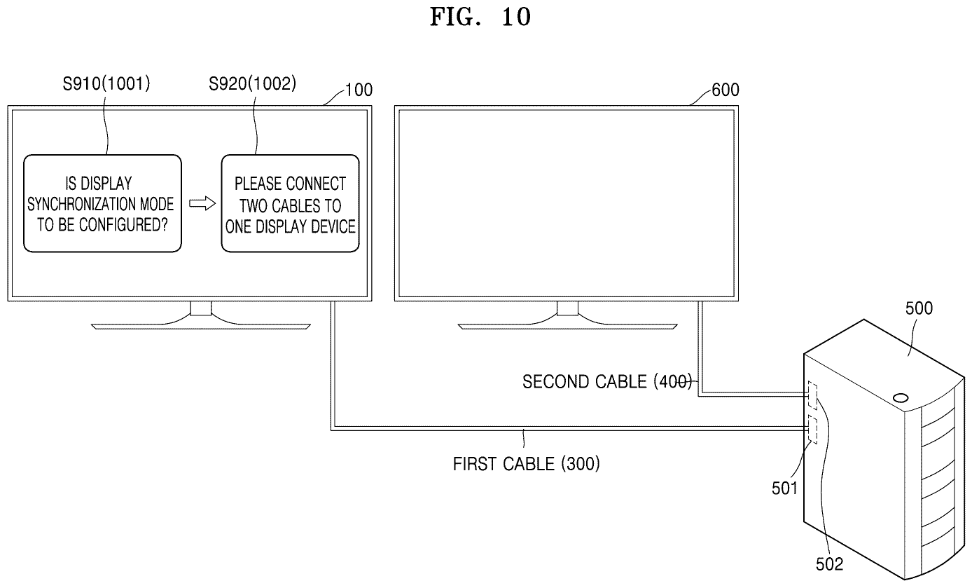

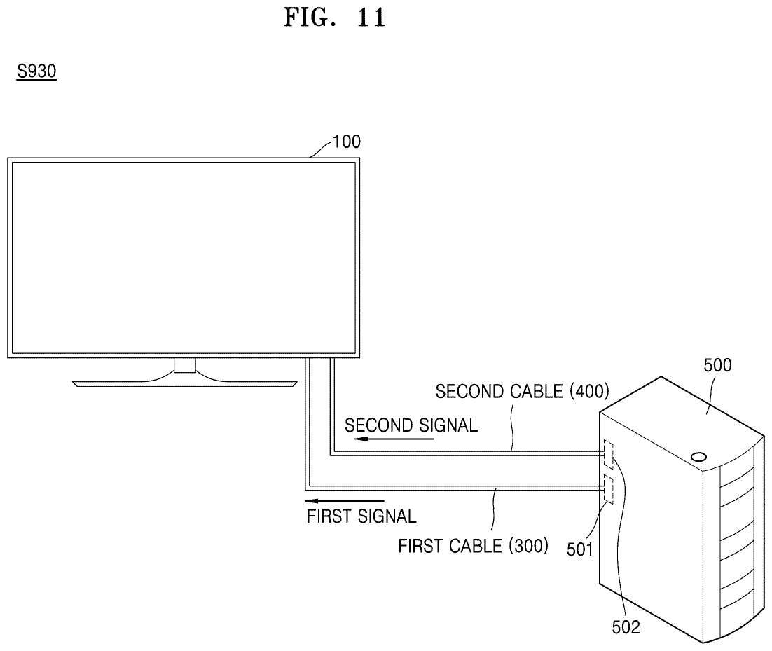

FIG. 9 is a flowchart illustrating an example operation, in which the display device 100 measures the signal input time difference according to a selection of the synchronization mode, according to various embodiments. FIG. 10 is a diagram illustrating an example operation of the display device 100 with respect to operations S910 and S920 of FIG. 9 according to various embodiments. FIG. 11 is a diagram illustrating an example operation of the display device 100 with respect to operation S930 of FIG. 9 according to various embodiments.

Referring to FIGS. 9, 10 and 11, the display device 100 may provide a user interface configured to configure the synchronization mode for synchronizing the booting time points of the plurality of display devices connected to one source device in the multi-display environment. When there is a user selection of the synchronization mode through the user interface, the display device 100 may perform an operation corresponding to the synchronization mode in the multi-display environment. The booting time points of the plurality of display devices may be synchronized to each other in the multi-display environment in which the synchronization mode is executed. Hereinafter, an operation, performed by the first display device 100, of providing the user interface for selecting the synchronization mode and of guiding an execution process of the synchronization mode, is described.

In operation S910, the controller 120 may provide the user interface for selecting a synchronization mode of the output time of the first signal received by the first display device 100 and the output time of the second signal received by the second display device 600 in the multi-display environment. For example, as illustrated in FIG. 10, the controller 120 may obtain whether or not the synchronization mode is selected, through a user interface 1001 showing “is a display synchronization mode to be configured?” For example, a user may select the synchronization mode through the user interface 1001.

According to an embodiment, the user interface may include a graphical user interface (GUI), a voice interface, etc. For example, when the user interface is a GUI, the user interface may be processed by the OSD processor 170 as an OSD and may be output through the display 130.

In operation S920, according to the selection of the synchronization mode through the user interface 1001, the controller 120 may output a message guiding the source device 500 and the first display device 100 to be connected to each other so that the first signal from the source device 500 is received by the first signal inputter 111 of the first display device 100, and the second signal from the source device 500 is received by the second signal inputter 112 of the first display device 100. For example, as illustrated in FIG. 11, the controller 120 may output a guide message 1002 of “please connect two cables to one display device.” The user may connect the first cable 300 and the second cable 400 to the first display device 100, according to the guide message 1002.

In operation S930, the controller 120 may identify whether or not the first signal inputter 111 of the first display device 100 and the second signal inputter 112 of the first display device 100 are connected to the source device 500. In detail, the controller 120 may determine whether the first signal inputter 111 of the first display device 100 is connected to the source device 500 through the first cable 300, and the second signal inputter 112 of the first display device 100 is connected to the source device 500 through the second cable 400 (see FIG. 11).

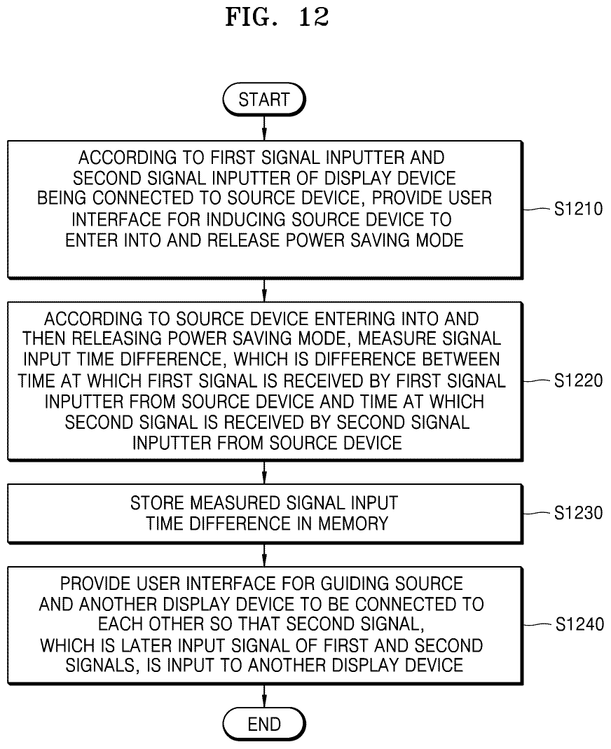

According to an embodiment, when the controller 120 determines that the first signal inputter 111 of the first display device 100 and the second signal inputter 112 of the first display device 100 are connected to the source device 500, the controller 120 may perform the operation of FIG. 12 to be described below. For example, after the controller 120 induces the display device 100 to enter into and release the power saving mode, the controller 120 may measure the signal input time difference and may guide a cable change to establish the multi-display environment in which the synchronization mode may be executed.

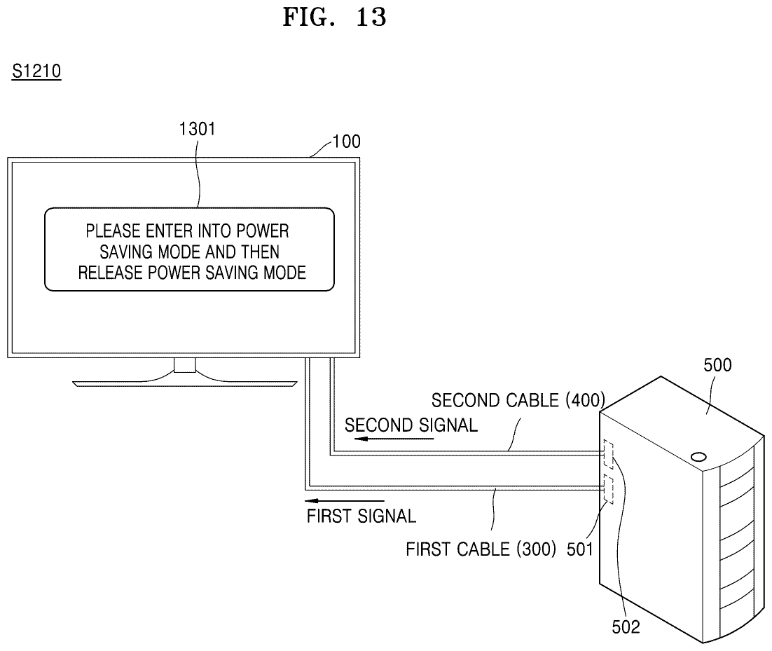

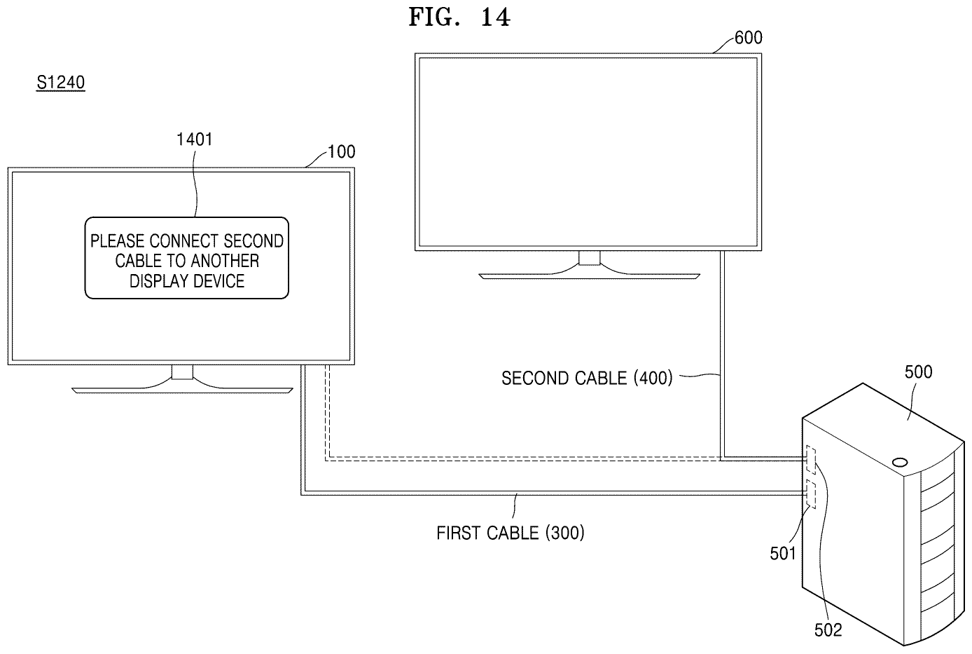

FIG. 12 is a flowchart illustrating an example operation, performed by the display device 100, of guiding a cable change, as a signal input time difference is measured, according to various embodiments. FIG. 13 is a diagram illustrating an example operation, performed by the display device 100, of providing a user interface for inducing the power saving mode to be entered into and then released, according to various embodiments. FIG. 14 is a diagram illustrating an example operation of guiding a cable change, as the signal input time difference is measured, according to various embodiments.

Referring to FIGS. 12, 13 and 14, after the controller 120 of the first display device 100 measures the signal input time difference, the controller 120 may guide the cable change to establish the multi-display environment in which the synchronization mode may be executed. Hereinafter, an operation process of the first display device 100 is described.

In operation S1210, according to the first signal inputter 111 and the second signal inputter 112 being connected to the source device 500, the controller 120 may provide the user interface for inducing the source device 500 to enter into and release the power saving mode.

According to an embodiment, as illustrated in FIG. 11, the first signal inputter 111 of the first display device 100 may be connected to the source device 500 through the first cable 300, and the second signal inputter 112 of the first display device 100 may be connected to the source device 500 through the second cable 400. The controller 120 may provide the user interface for inducing the source device 500 to enter into and release the power saving mode. For example, as illustrated in FIG. 13, the controller 120 may output a user interface 1301 of “please enter into a power saving mode and then release the power saving mode.” When the user interface is a GUI, the user interface may be processed by the OSD processor 170 as an OSD and may be output through the display 130. The source device 500 may enter into and then release the power saving mode according to a user input, etc.

The source device 500 entering into the power saving mode may not provide a signal to the first display device 100. According to an embodiment, when an additional signal is not input to the first signal inputter 111 and the second signal inputter 112 of the first display device 100, the controller 120 may switch from a first power mode to a second power mode. The first power mode may be a general mode having a high-speed clock signal, and the second power mode may be a low power mode having a low-speed clock signal. According to an embodiment, when an additional signal is not input to the first signal inputter 111 and the second signal inputter 112 of the first display device 100, the low power controller of the controller 120 may be activated, but the main controller may be deactivated.

In operation S1220, according to the source device 500 entering into and then releasing the power saving mode, the controller 120 may measure a signal input time difference, which is a difference between a time at which the first signal from the source device 500 is received by the first signal inputter 111 and a time at which the second signal from the source device 500 is received by the second signal inputter 112. Operation S1220 may be the same as the descriptions of FIG. 7.

According to an embodiment, the source device 500 releasing the power saving mode may provide a plurality of signals to the first display device 100. The first signal inputter 111 of the first display device 100 may receive the first signal, which is an earlier input signal, and the second signal inputter 112 may receive the second signal, which is a later input signal. The controller 120 may measure the signal input time difference between the first signal and the second signal. Also, the controller 120 may identify a later signal of the first and second signals.

According to an embodiment, when the power saving mode is released, the controller 120 may switch from the second power mode to the first power mode. According to an embodiment, the low power controller of the controller 120 may output an activation signal to activate the main controller. When the power saving mode is released, the first display device 100 may perform a booting operation.

In operation S1230, the controller 120 may store the measured signal input time difference in the memory 150. The controller 120 may store the later signal of the first and second signals in the memory 150. The first display device 100 may delay an output of the signal received by the signal inputter 110, based on the signal input time difference stored in the memory 150, in the multi-display environment.

In operation S1240, the controller 120 may provide a user interface for guiding the source device 500 and the second display device 600 to be connected to each other so that the second signal, which is the later input signal of the first and second signals, may be input to the second display device 600. For example, as illustrated in FIG. 14, the controller 120 may output a user interface 1401 of “please connect the second cable to another display device.” When the user interface 1401 is a GUI, the user interface 1401 may be processed by the OSD processor 170 as an OSD and may be output through the display 130. The user may change the second cable 400 to be connected to the second display device 600, according to the user interface 1401.

For example, after the controller 120 measures the signal input time difference between the first signal and the second signal, the controller 120 may delay an output of the first signal, which is the earlier input signal, to synchronize the output of the first signal to an output of the second signal, which is the later input signal. In order to delay the output of the first signal, which is the earlier input signal, the controller 120 may guide the first cable 300 transmitting the first signal, which is the earlier input signal, to maintain to be connected to the first display device 100 and may guide the second cable 400 transmitting the second signal, which is the later input signal, to be connected to the second display device 600. That is, because the first display device 100 measuring the signal input time difference my perform a synchronization control operation as required to match the signal input time difference, the first display device 100 may guide the first display device 100 to receive the earlier input signal and the second display device 600 to receive the later input signal. Accordingly, the first display device 100 storing the signal input time difference between the first signal and the second signal may delay the output of the first signal as required to match a time corresponding to the signal input time difference. In the multi-display environment, a booting operation of the first display device 100 and a booting operation of the second display device 600 may be synchronized to each other, and an output time of the first signal and an output time of the second signal may be synchronized to each other, and thus, even when the power saving mode is entered into and then released, movement of images between the plurality of display devices may be prevented and/or reduced.

According to an embodiment, when the source device 500 has information corresponding to the signal input time difference between the plurality of display devices, the configuration of the synchronization mode may be omitted. For example, the source device 500 may pre-store information about an image transmission interface connected to the first display device 100 and information about an image transmission interface connected to the second display device 600. In this case, without measuring the signal input time difference by the first display device 100, the booting operations of the first display device 100 and the second display device 600 may be synchronized to each other by the source device 500.

According to an embodiment, when the display device 100 has booting time information according to the plurality of image transmission interfaces, the configuration of the synchronization mode may be omitted. For example, each of the plurality of display devices may have data of the booting time information according to each image transmission interface. The booting operation of each of the plurality of display devices may be synchronized to each other, based on the data of the booting time information.

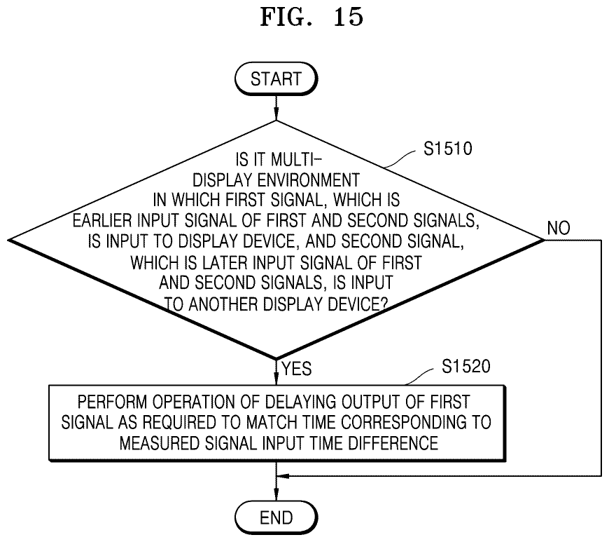

FIG. 15 is a flowchart illustrating an example operation after execution of a synchronization mode in a multi-display environment, according to various embodiments.

Referring to FIG. 15, in the multi-display environment in which the synchronization mode is executed, the first display device 100 may delay an output of a signal having an earlier input time to synchronize outputs of the signals according to different image transmission interfaces.

In operation S1510, the controller 120 may determine whether it is a multi-display environment in which a first signal, which is an earlier signal of the first signal and a second signal, is input to the first display device 100, and the second signal, which is a later signal of the first and second signals, is input to the second display device 600. When the controller 120 determines that it is the multi-display environment, the controller 120 may perform operation S1520.

In operation S1520, the controller 120 may perform an operation of delaying an output of the first signal as required to match a time corresponding to a measured signal input time difference. Operation S1520 may be performed as illustrated in FIG. 8.

For example, after the controller 120 measures the signal input time difference between the first signal and the second signal, the controller 120 may delay the output of the first signal, which is the earlier input signal, as required to match the time corresponding to the signal input time difference, to synchronize the output of the first signal to an output of the second signal, which is the later input signal. In the multi-display environment, booting operations of the first display device 100 and the second display device 600 may be synchronized to each other, and output times of the first and second signals may be synchronized to each other, and thus, even when a power saving mode is entered into and then released, transferring of images between the plurality of display devices may be prevented and/or reduced.

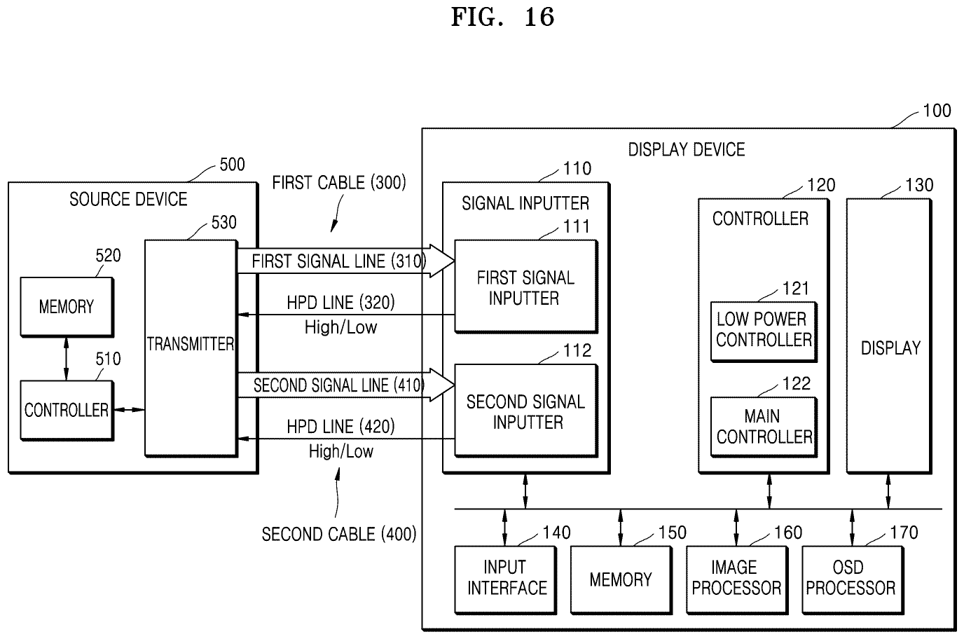

Referring to FIGS. 16, 17 and 18, operations of the low power controller 121 and the main controller 122, when the controller 120 of the display device 100 according to an embodiment includes the low power controller 121 and the main controller 122, are described.

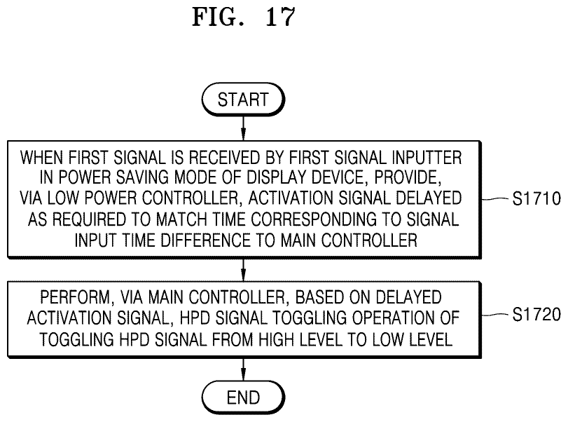

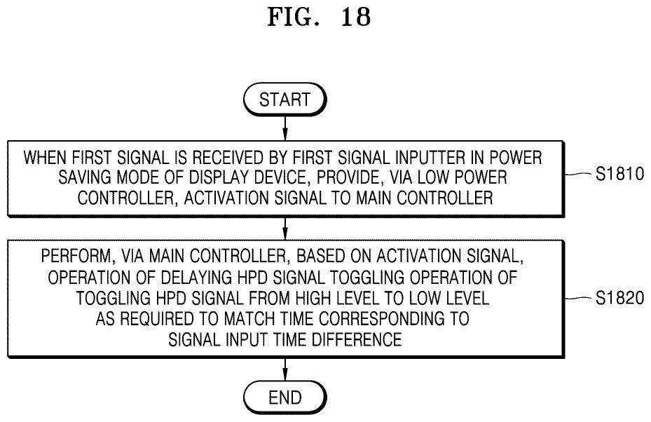

FIG. 16 is a block diagram illustrating an example configuration of the display device 100 and the source device 500 according to various embodiments. FIG. 17 is a flowchart illustrating an example booting synchronization operation in a multi-display environment in which a synchronization mode is executed, according to various embodiments. FIG. 18 is a flowchart illustrating an example booting synchronization operation in a multi-display environment in which a synchronization mode is executed, according to various embodiments.

Referring to FIG. 16, the controller 120 may include the low power controller (e.g., including control/processing circuitry) 121 and the main controller (e.g., including control/processing circuitry) 122. The low power controller 121 may be activated in the power saving mode, but the main controller 122 may be deactivated in the power saving mode.

The low power controller 121 according to an embodiment may include various control/processing circuitry and identify that an input of a signal received by the signal inputter 110, measure a signal input time difference, and store the signal input time difference in the memory 150. When the power saving mode of the source device 500 is released, the low power controller 121 may identify the signal input of the signal inputter 110 and may output an activation signal to activate the main controller 122.

The main power controller 122 according to an embodiment may include various control/processing circuitry and be activated according to the activation signal of the low power controller 121 and start a booting operation. After the booting operation is completed, the main controller 122 may toggle an HPD signal level and provide a booting completion event to the source device 500. The main controller 122 may process the received signal through the image processor 160 and may output the processed image processor through the display 130.

Referring to FIG. 17, a method, performed by the controller 120, of delaying a booting operation of the first display device 100 as required to match a time corresponding to a signal input time difference, according to an embodiment, is described.

In operation S1710, when the low power controller 121 receives a first signal through the first signal inputter 111 in a power saving mode of the first display device 100, the low power controller 121 may provide an activation signal, which is delayed as required to match a time corresponding to the signal input time difference, to the main controller 122.

In operation S1720, the main controller 122 may perform an HPD signal toggling operation of toggling an HPD signal from a high level to a low level, based on the delayed activation signal.

According to an embodiment, in the power saving mode of the first display device 100, the low power controller 121 may identify that the first signal is received by the first signal inputter 111. The low power controller 121 may delay activation of the main controller 122 in order to synchronize booting operations of the plurality of display devices. The low power controller 121 may read the signal input time difference stored in the memory 150 and may provide an activation signal delayed as required to match the time corresponding to the signal input time difference to the main controller 122, thereby simultaneously booting the first display device 100 and the second display device 600.

The booting operation of the main controller 122 is delayed according to the delayed activation signal, and thus, the HPD signal toggling operation may also be delayed. The HPD signal toggling operation of the first display device 100 may be synchronized to an HPD signal toggling operation of the second display device 600, and thus, even when the plurality of display devices perform the booting operations, transferring of images between the plurality of display devices may not occur.

Referring to FIG. 18, a method, performed by the controller 120, of delaying a booting operation of the first display device 100 as required to match a time corresponding to a signal input time difference, according to various embodiments, is described.

In operation S1810, when a first signal is received by the first signal inputter 111 in a power saving mode of the first display device 100, the low power controller 121 may provide an activation signal to the main controller 122.

In operation S1820, based on the activation signal, the main controller 122 may perform an operation of delaying an HPD signal toggling operation of toggling an HPD signal from a high level to a low level as required to match a time corresponding to the signal input time difference.

According to an embodiment, the low power controller 121 may provide the activation signal to the main controller 122 in order to boot the first display device 100. The activated main controller 122 may read the signal input time difference stored in the memory 150 and may delay the HPD signal toggling operation as required to match the time corresponding to the signal input time difference, in order to synchronize booting operations of the plurality of display devices. Accordingly, the HPD signal toggling operation of the first display device 100 may be synchronized to an HPD signal toggling operation of the second display device 600, and thus, even when the plurality of display devices perform booting operations, image transferring between the plurality of display devices may not occur.

However, when the controller 120 operates in the first power mode and the second power mode, the controller 120 may perform an operation of delaying a switch of the power modes, in order to delay the booting operation. For example, the controller 120 may operate in the second power mode of a low-speed clock signal in the power saving mode of the first display device 100, and when the first signal is received by the first signal inputter 111, may switch to the first power mode of a high-speed clock signal. The controller 120 may perform the operation of delaying the switch from the second power mode to the first power mode.

The controlling method of the display device 100 according to an embodiment of the present disclosure may include: measuring a signal input time difference, which is a difference between a time at which a first signal is received by the first signal inputter 111 from the source device 500 and a time at which a second signal is received by the second signal inputter 112 from the source device 500; and based on the measured signal input time difference, controlling a signal output time of the first signal received by the display device 100, in a multi-display environment in which the display device 100 receives the first signal and another display device 600 receives the second signal.

Even when the signal input times of the first signal input to the display device 100 and the second signal input to the other display device 600 are different from each other, positions of images displayed on the display device 100 and the other display device 600 may be maintained. That is, even when a power saving mode is used in the multi-display environment, transferring of images between the plurality of display devices may be prevented and/or reduced. Because the positions of the images configured by a user are not changed, user convenience may be improved.

In the multi-display environment, to control a signal output time of the first signal received by the display device 100, a booting operation of the display device 100 may be delayed as required to match a time corresponding to the signal input time difference.

The controlling of the signal output time of the first signal may include delaying the signal output of the first signal as required to match the time corresponding to the signal input difference.

In the multi-display environment, the user interface 1001 for selecting a synchronization mode of the output time of the first signal received by the display device 100 and an output time of the second signal received by the other display device 600 may be provided. According to a selection of the synchronization mode through the user interface 1001, the message 1002 configured guide the source device 500 and the first display device 100 to be connected to each other so that the first signal from the source device 500 may be received by the first signal inputter 111 of the display device 100, and the second signal from the source device 500 may be received by the second signal inputter 112 of the display device 100 may be output.

According to the first signal inputter 111 and the second signal inputter 112 being connected to the source device 500 so that the first signal from the source device 500 is received by the first signal inputter 111 of the display device 100, and the second signal from the source device 500 is received by the second signal inputter 112 of the display device 100, the user interface 1301 for inducing the source device 500 to enter into and release a power saving mode may be provided.

According to the source device 500 entering into and then releasing the power saving mode, a signal input time difference, which is a difference between a time at which the first signal is received and a time at which the second signal is received, may be measured.

Based on the signal input time difference, the user interface 1401 for guiding the source device 500 and the other device 600 to be connected to each other so that the second signal, which is a later input signal of the first and second signals, may be received by the other display device 600 may be provided.

In the multi-display environment, an operation of delaying an HPD signal toggling operation of toggling an HPD signal from a high level to a low level, as required to match the time corresponding to the signal input time difference, may be performed.

In the multi-display environment, when the first signal is received by the first signal inputter 111 in the power saving mode of the display device 100, the low power controller 121 may provide an activation signal delayed as required to match the time corresponding to the signal input time difference to the main controller 122. The main controller 122 may perform, based on the delayed activation signal, an HPD signal toggling operation of toggling an HPD signal from a high level to a low level.

In the multi-display environment, when the first signal is received by the first signal inputter 111 in the power saving mode of the display device 100, the low power controller 121 may provide an activation signal to the main controller 122. The main controller 122 may perform, based on the activation signal delay, an operation of delaying an HPD signal toggling operation of toggling an HPD signal from a high level to a low level, as required to match the time corresponding to the signal input time difference.

Various embodiments may be implemented by a recording medium including a computer-executable instruction, such as a program module executed by a computer. The computer-readable medium may be an arbitrary available medium accessible by a computer and includes all of volatile and non-volatile media and detachable and non-detachable media. The computer-readable media may include computer storage media. The computer storage medium includes all of volatile and non-volatile media and detachable and non-detachable media that are realized by an arbitrary method or technique for storing information, such as computer-readable instructions, data structures, program modules, or other data.

The various example embodiments may be realized as a software (S/W) program including instructions stored in computer-readable storage media.

A computer may include a device for calling the instructions stored in the storage media and performing, in response to the called instructions, operations according to the disclosed embodiments, and may include the electronic device according to the disclosed embodiments.

The computer-readable storage media may include non-transitory storage media. Here, the “non-transitory” denotes that the non-transitory storage media do not include a signal and are tangible, and does not distinguish whether the storage media semi-permanently or temporarily store the data.

The controlling methods according to the various example embodiments may be included in a computer program product. The computer program product may be transacted between a seller and a purchaser, as a product.

The computer program product may include an S/W program or a computer-readable storage medium in which the S/W program is stored. For example, the computer program product may include a product in the form of an S/W program (for example, a downloadable application) that is electronically distributed through a manufacturer of a device or an electronic market (for example, a Google play store or an App store). For electronic distribution, at least a portion of the S/W program may be stored in a storage medium or temporarily generated. In this case, the storage medium may include a server of a manufacturer, a server of an electronic market, or a storage medium of a broadcasting server temporarily storing the software program.

In a system including a server and a device, the computer program product may include a storage medium of the server or a storage medium of the device. Alternatively, when there is a third device (for example, a smartphone) connected to the server or the device for communication, the computer program product may include a storage medium of the third device. Alternatively, the computer program product may directly include an S/W program transmitted from the server to the device or the third device or transmitted from the third device to the device.

In this case, any one of the server, the device, and the third device may perform the method according to the disclosed embodiments by executing the computer program product. Alternatively, at least two of the server, the device, and the third device may perform the method according to the disclosed embodiments in a distributed fashion by executing the computer program product.

For example, the server (for example, a cloud server or an artificial intelligence (AI) server) may execute the computer program product stored in the server to control the device connected to the server for communication to perform the methods according to the disclosed embodiments.

As another example, the third device may execute the computer program product to control the device connected to the third device for communication to perform the method according to the disclosed embodiments. When the third device executes the computer program product, the third device may download the computer program product from the server and execute the downloaded computer program product. Alternatively, the third device may execute the computer program product provided in a pre-loaded state to perform the method according to the disclosed embodiments.

In the disclosure, a “unit” may refer to a hardware component, such as a processor or a circuit, and/or a software component executed by a hardware component such as a processor.

The above descriptions of the present disclosure are examples, and it would be understood by one of ordinary skill in the art that the disclosure may be easily modified as other specific forms without changing the technical concept or essential features of the disclosure. Hence, it will be understood that the various example embodiments described above are examples in all aspects and are not limiting of the scope of the disclosure. For example, each of components described as a single unit may be executed in a distributed fashion, and likewise, components described as being distributed may be executed in a combined fashion.

The scope of the present disclosure includes the claims, and it should be understood that the claims and all modifications or modified forms drawn from the concept of the claims are included in the scope of the present disclosure.

In this disclosure, the various embodiments and the features described above may be combined with each other, unless their combination incurs apparent technical collision.

What is claimed is:

1. A display device comprising:
a display;
a first signal inputter comprising circuitry;
a second signal inputter comprising circuitry; and
a controller comprising circuitry, wherein the controller is configured to:
measure a signal input time difference between a time at which a first signal is received by the first signal inputter from a source device and a time at which a second signal is received by the second signal inputter from the source device;
wherein, in a multi-display environment in which the display device receives the first signal and another display device receives the second signal, perform, based on the measured signal input time difference, an operation for controlling a signal output time of the first signal received by the display device.

2. The display device of claim 1, wherein the controller is further configured to, in the multi-display environment, delay a booting operation of the display device to match a time corresponding to the signal input time difference, to control the signal output time of the first signal received by the display device.

3. The display device of claim 1, wherein the controlling the signal output time of the first signal comprises delaying a signal output of the first signal to match a time corresponding to the signal input time difference.

4. The display device of claim 1, wherein the controller is further configured to: provide a user interface configured to select a synchronization mode of an output time of the first signal received by the display device and an output time of the second signal received by the other display device in the multi-display environment; and, based on a selection of the synchronization mode through the user interface, output a message for guiding the source device and the display device to be connected to each other so that the first signal from the source device can be received by the first signal inputter of the display device, and the second signal from the source device can be received by the second signal inputter of the display device.

5. The display device of claim 1, wherein the controller is further configured to: based on the first signal inputter and the second signal inputter being connected to the source device so that the first signal from the source device can be received by the first signal inputter of the display device, and the second signal from the source device can be received by the second signal inputter of the display device, provide a user interface for inducing the source device to enter into and release a power saving mode; and based on the source device entering into and then releasing the power saving mode, measure the time signal input difference between the time at which the first signal is received and the time at which the second signal is received.

6. The display device of claim 1, wherein the controller is further configured to provide a user interface for guiding the source device and the other display device to be connected to each other so that the second signal, which is a later input signal of the first signal and the second signal, based on the signal input time difference, can be input to the other display device.

7. The display device of claim 1, wherein the controller is further configured to, in the multi-display environment, perform an operation of delaying a hot plug detect (HPD) signal toggling operation of toggling an HPD signal from a high level to a low level, to match a time corresponding to the signal input time difference.

8. The display device of claim 1, wherein the controller comprises a low power controller and a main controller, and in the multi-display environment, based on the first signal being received by the first signal inputter in a power saving mode of the display device, the low power controller is configured to provide, to the main controller, an activation signal delayed to match a time corresponding to the signal input time difference, and the main controller is configured to perform, based on the delayed activation signal, an HPD signal toggling operation of toggling an HPD signal from a high level to a low level.

9. The display device of claim 1, wherein the controller comprises a low power controller and a main controller, and in the multi-display environment, based on the first signal being received by the first signal inputter in a power saving mode of the display device, the low power controller is configured to provide an activation signal to the main controller, and the main controller is configured to perform, based on the activation signal, an operation of delaying an HPD signal toggling operation of toggling an HPD signal from a high level to a low level, to match a time corresponding to the signal input time difference.

10. The display device of claim 1, wherein the controller is further configured to store the second signal, which is a later input signal of the first and second signals, in the memory.

11. The display device of claim 1, wherein the first signal is received by the first signal inputter through an auxiliary (Aux) channel, and the second signal is received by the second signal inputter through a transition minimized differential signaling (TMDS) line based on a TMDS clock signal.

12. A method of controlling a display device, the method comprising: measuring a signal input time difference between a time at which a first signal is received by a first signal inputter from a source device and a time at which a second signal is received by a second signal inputter from the source device; and in a multi-display environment in which the display device receives the first signal and another display device receives the second signal, controlling, based on the measured signal input time difference, a signal output time of the first signal received by the display device.

13. The method of claim 12, further comprising, in the multi-display environment, delaying a booting operation of the display device to match a time corresponding to the signal input time difference, to control the signal output time of the first signal received by the display device.

14. The method of claim 12, wherein the controlling of the signal output time of the first signal comprises delaying a signal output of the first signal to match a time corresponding to the signal input time difference.

15. The method of claim 12, further comprising:
providing a user interface for selecting a synchronization mode of the signal output time of the first signal received by the display device and a signal output time of the second signal received by the other display device in the multi-display environment; and
based on a selection of the synchronization mode through the user interface, outputting a message for guiding the source device and the display device to be connected to each other so that the first signal from the source device can be received by the first signal inputter of the display device, and the second signal from the source device can be received by the second signal inputter of the display device.
